(19) United States
(12) Patent Application Publication
(10) Pub. No.: US 2025/0026131 A1
(43) Pub. Date: Jan. 23, 2025

(54) LIQUID CONTAINER, PRINTING APPARATUS, LIQUID CONTAINER MANUFACTURING APPARATUS, AND LIQUID CONTAINER MANUFACTURING METHOD

(71) Applicant: CANON KABUSHIKI KAISHA, Tokyo (JP)

(72) Inventors: TAKETSUGU MURAKAMI, Kanagawa (JP); HIROKI HAYASHI, Kanagawa (JP); YASUNORI TAKEI, Tokyo (JP)

(21) Appl. No.: 18/910,371

(22) Filed: Oct. 9, 2024

Related U.S. Application Data
(63) Continuation of application No. PCT/JP2023/011278, filed on Mar. 22, 2023.

(30) Foreign Application Priority Data
Apr. 28, 2022 (JP) 2022-074485
Feb. 22, 2023 (JP) 2023-026131

(51) Int. Cl. B41J 2/175; B41J 2/18

(52) U.S. Cl. CPC B41J 2/17596; B41J 2/17523; B41J 2/17553; B41J 2/17559; B41J 2/18

(57) ABSTRACT

A liquid container includes a bag body and an outlet unit. The outlet unit has a supply channel unit and a bypass channel unit. In the supply channel unit, a check valve is disposed which permits a liquid to be delivered to a printing apparatus from the bag body and does not permit the liquid to be delivered to the bag body from the printing apparatus. In the bypass channel unit, an on-off valve is disposed which is movable to a first position where the valve closes the bypass channel unit to not permit the liquid to be delivered and to a second position where the valve opens the bypass channel unit to permit the liquid to be delivered. The valve is freely moved between the first and second positions by being operated by a tool from outside the container to switch opening and closing of the bypass channel unit.

### CROSS-REFERENCE TO RELATED APPLICATIONS

This application is a Continuation of International Patent Application No. PCT/JP2023/011278, filed Mar. 22, 2023, which claims the benefit of Japanese Patent Applications No. 2022-074485, filed Apr. 28, 2022, and No. 2023-026131, filed Feb. 22, 2023, all of which are hereby incorporated by reference herein in their entirety.

### BACKGROUND

### Field of the Disclosure

The present disclosure relates to a liquid container, a printing apparatus, a liquid container manufacturing apparatus, and a liquid container manufacturing method.

### Background Art

### Citation List

### Patent Literature

PTL 1: Japanese Patent Laid-Open No. 2005-225164
PTL 2: Japanese Patent Laid-Open No. 2005-199448

PTL 1 discloses an ink pack with an outlet unit to be connected to a printer, the outlet unit being provided with a liquid channel through which a liquid to be discharged to the printer and a bypass channel through which the liquid flows in a case of being filled into the liquid container.

PTL 2 discloses a configuration which, in a case of re-filling a liquid into an ink cartridge through an ink outlet tube, opens or closes a valve element in the ink outlet tube by using a magnet disposed outside the ink outlet tube.

Also, in recent years, there has been a need to start printing with a printing apparatus after making the density of a liquid contained in a liquid container uniform.

Here, in a case where a liquid is filled into the ink pack disclosed in PTL 1 at the time of assembling the printer, the bypass channel is closed by the thermal welding. Thus, it will be impossible to re-fill a liquid into the ink pack through the bypass channel.

Also, while a liquid can be re-filled into the liquid container disclosed in PTL 2 through the ink outlet tube, there is a possibility that the on-off valve may open and close in a case where the user brings a magnet near the on-off valve by mistake. Moreover, the valve element's opened state in the liquid container disclosed in PTL 2 may become unstable during the re-filling of the ink due to the ink's dynamic pressure. Thus, there is a possibility that the valve element's operation may lack reliability.

### SUMMARY

Thus, an object of the present disclosure is to provide a liquid container capable of stably opening and closing a valve element thereof in a case of filling a liquid into the liquid container.

To achieve the above object, a liquid container according to the present disclosure is a liquid container to be detachably mounted to a container mounting portion of a printing apparatus, including: a bag body which contains a liquid therein; and an outlet unit having a supply channel unit which permits the liquid to be delivered to the printing apparatus from the bag body, and a bypass channel unit which permits the liquid to be delivered to the bag body from the printing apparatus, in which in the supply channel unit, a check valve is disposed which permits the liquid to be delivered to the printing apparatus from the bag body and does not permit the liquid to be delivered to the bag body from the printing apparatus, in the bypass channel unit, an on-off valve is disposed which is configured to be movable to a first position and a second position, the first position being a position at which the on-off valve closes the bypass channel unit to not permit the liquid to be delivered, the second position being a position at which the on-off valve opens the bypass channel unit to permit the liquid to be delivered, and the on-off valve is configured to be freely moved between the first position and the second position by being operated by a tool from outside the liquid container to thereby switch opening and closing of the bypass channel unit.

Further features of the present disclosure will become apparent from the following description of exemplary embodiments with reference to the attached drawings.

### BRIEF DESCRIPTION OF THE DRAWINGS

FIG. 1 is a perspective view illustrating a schematic configuration of a printing apparatus.

FIG. 2 is a schematic diagram illustrating channels in a whole system.

FIG. 3 is a transparent perspective view illustrating a schematic configuration of a liquid container.

FIG. 4 is a schematic cross-sectional view along the IV-IV line in FIG. 3.

FIG. 5A is an exploded perspective view of the liquid container as seen from the back side.

FIG. 5B is an exploded perspective view of the liquid container as seen from the front side.

FIG. 6A is a view illustrating a state before the liquid container is mounted to the printing apparatus.

FIG. 6B is a view illustrating a state after the liquid container is mounted to the printing apparatus.

FIG. 6C is a view illustrating a state where a bypass channel unit is getting opened.

FIG. 7 is a schematic diagram illustrating channels in a whole system.

FIG. 8 is a transparent perspective view illustrating a schematic configuration of a liquid container.

FIG. 9 is a schematic cross-sectional view along the IX-IX line in FIG. 8.

FIG. 10A is a view illustrating a state before the liquid container is mounted to the printing apparatus.

FIG. 10B is a view illustrating a state after the liquid container is mounted to the printing apparatus.

FIG. 10C is a view illustrating a state where a bypass channel unit is opened.

FIG. 11 is a schematic diagram illustrating channels in a whole system.

FIG. 12 is a transparent perspective view illustrating a schematic configuration of a liquid container.

FIG. 13 is a schematic cross-sectional view along the XIII-XIII line in FIG. 12.

FIG. 14A is a view illustrating a state before a hollow needle and a third dedicated tool are inserted in the liquid container.

FIG. 14B is a view illustrating a state after the third dedicated tool is inserted into the liquid container.

FIG. 14C is a view illustrating a state after the hollow needle is inserted into the liquid container.

### DESCRIPTION OF THE EMBODIMENTS

Preferred embodiments of the present disclosure will be specifically described below with reference to the accompanying drawings. Note that the following embodiments do not limit the contents of the present disclosure, and not all of the combinations of the features described in these embodiments are necessarily essential for the solution to be provided by the present disclosure.

### First Embodiment

### <Printing Apparatus 100>

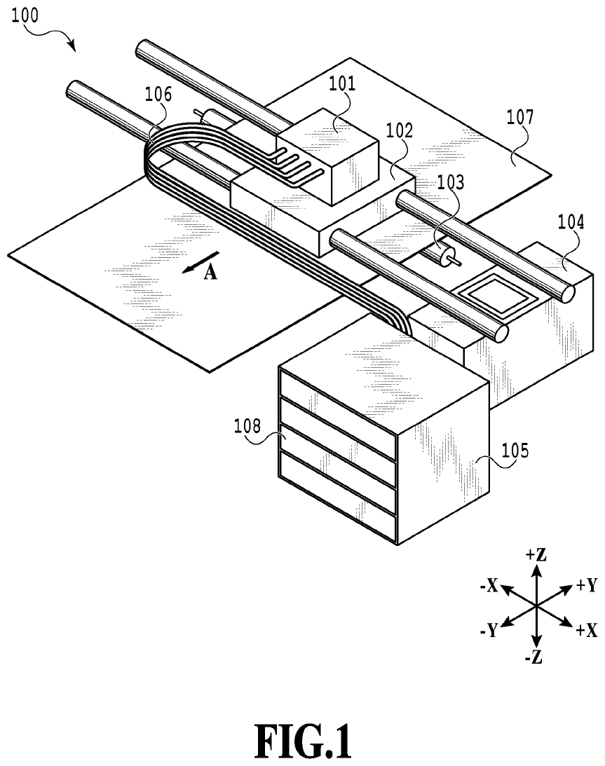

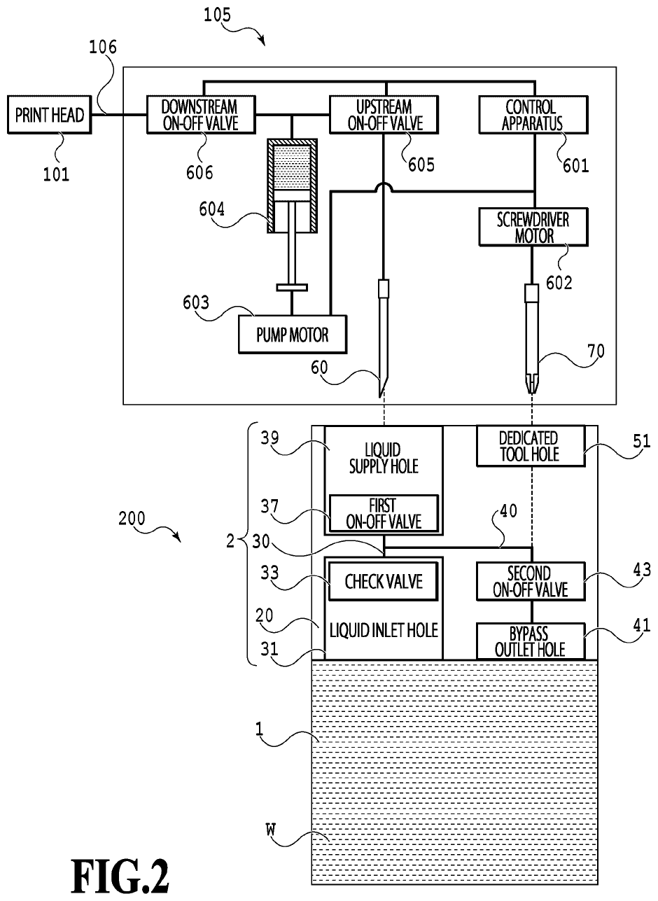

FIG. 1 is a perspective view illustrating a schematic configuration of a printing apparatus 100 in a first embodiment. As illustrated in FIG. 1, the printing apparatus 100 has a print head 101, a carriage 102, a conveyance roller 103, a recovery unit 104, a liquid supply unit 105, and liquid supply tubes 106. The liquid supply unit 105 has trays 108 each of which accommodates a liquid container 200 (see FIG. 2).

The printing apparatus 100 repeats reciprocal movement of the print head 101 (main scan) and conveyance of a print sheet 107, which is a print medium, by a predetermined pitch (sub scan). By selectively ejecting liquids (e.g., inks) of multiple colors from the print head 101 and causing them to land on the print sheet 107, which is a print medium, in synchronization with the above movements, the printing apparatus 100 performs a printing operation of forming characters, symbols, an image, and/or the like. Note that any print medium may be used as long as droplets can land thereon to form an image. For example, various materials in various forms, such as paper, fabric, an optical disc's label surface, a plastic sheet, an overhead projector (OHP) sheet, and an envelope, can be used as the print medium.

In FIG. 1, the print head 101 is detachably mounted on the carriage 102, which is slidably supported by two guide rails and linearly reciprocally moved along the guide rails by a driving unit not illustrated, such as a motor. The print sheet 107 to receive the liquids to be ejected from a liquid ejection unit of the print head 101 is conveyed by the conveyance roller 103, which is a conveyance unit, in a direction crossing the movement direction of the carriage 102 (the direction indicated by the arrow A in FIG. 1) so as to face the liquid ejection surface of the print head 101.

The print head 101 has multiple nozzle arrays for ejecting liquids of different colors as multiple liquid ejection units. Multiple independent liquid containers 200 (see FIG. 2) each having a liquid supply hole 39 (see FIG. 2) and corresponding to one of the colors of the liquids to be ejected from the print head 101 are detachably mounted on a container mounting portion of the printing apparatus 100 (e.g., the liquid supply unit 105).

Here, the liquid containers 200 are accommodated in the respective trays 108. In the trays 108, the liquid containers 200 are accommodated in a predetermined posture. Note that the liquid containers 200 do not necessarily have to be accommodated in the trays 108. For example, the liquid containers 200 may be accommodated in box-shaped cases.

The liquid supply unit 105 and the print head 101 are connected by multiple liquid supply tubes 106 for the colors of the respective liquids. As the user moves the trays 108 accommodating the liquid containers 200 forward to mount them to the liquid supply unit 105, the liquids of the multiple colors contained in the liquid containers 200 will be able to be independently supplied to the respective nozzle arrays in the print head 101.

In the present embodiment, the liquid supply unit 105 has a pump mechanism 604 (see FIG. 2) and is capable of sucking the liquids out of the liquid containers 200 and delivering them to the print head 101. Using the pump mechanism 604, the liquid supply unit 105 is also capable of sending the liquids sucked out of the liquid containers 200 back to the liquid containers 200 (that is, circulating the liquids).

The recovery unit 104 is disposed so as to face the liquid ejection surface of the print head 101 at a non-printing area which is an area situated inside the range in which the print head 101 is reciprocally moved and outside the range through which the print sheet 107 is passed. The recovery unit 104 has a cap unit for capping the liquid ejection surface of the print head 101, a suction mechanism for forcibly sucking the liquids with the liquid ejection surface capped, a cleaning blade for wiping off dirt on the liquid ejection surface, and the like. This recovery unit 104 performs the above suction operation prior to a printing operation to be performed the printing apparatus 100. In this way, even in a case where the printing apparatus 100 is caused to operate after being left unused for a long period of time, bubbles remaining inside the ejection unit of the print head 101 and thickened liquids near ejection ports can be removed by performing a recovery process with the recovery unit 104. Accordingly, ejection characteristics of the print head 101 will be maintained.

In the present embodiment, the direction in which the liquid containers 200 are mounted to the liquid supply unit 105 is defined as an +Y direction. The direction in which the liquid containers 200 are dismounted from the liquid supply unit 105 is defined as a −Y direction. The width direction of the liquid container 200 (i.e., a direction orthogonal to the Y direction in a plane) is defined as an X direction. Note that the leftward direction in FIG. 1 is defined as a −X direction. The rightward direction in FIG. 1 is defined as a +X direction. The height direction of the liquid container 200 is defined as a Z direction. The direction of gravity (a direction toward the lower side of FIG. 1) is defined as a −Z direction. The direction opposite to gravity (a direction toward the upper side of FIG. 1) is defined as a +Z direction.

### <Channels in Whole System>

FIG. 2 is a schematic diagram illustrating channels in a whole system in the present embodiment. Note that a description will be given with FIG. 2 by taking the channels for one color. Also, the scales of each part and component illustrated in FIG. 2 are merely schematic and differ from the actual scales. As illustrated in FIG. 2, the system in the present embodiment includes the liquid supply unit 105 and the liquid container 200 (e.g., an ink pack).

The liquid supply unit 105 includes a control apparatus 601, a screwdriver motor 602 whose rotation is controlled by the control apparatus 601, and a first dedicated tool 70 (e.g., powered screwdriver). Note that the control apparatus 601 does not need to be incorporated in the liquid supply unit 105. Also, a “dedicated tool” only needs to have a function of opening and closing an on-off valve (e.g., a second on-off valve 43) provided to a channel for returning the liquid to the liquid container 200 from the printing apparatus 100 (e.g., the bypass channel unit to be described later). That is, a “dedicated tool” may be a tool having a function other than opening and closing an on-off valve. The expression “dedicated” shall not be interpreted in a particularly restrictive manner herein. In the following, the term “dedicated tool” will be used for convenience. Also, in FIG. 2, only a tip portion (an end portion in the −Y direction) of the first dedicated tool 70 is illustrated. The liquid supply unit 105 includes a pump motor 603 whose driving is controlled by the control apparatus 601, and the pump mechanism 604, which is driven by the pump motor 603. The liquid supply unit 105 includes an upstream on-off valve 605 provided upstream of the pump mechanism 604, a hollow needle 60 connected to the channel to which the upstream on-off valve 605 is provided, and a downstream on-off valve 606 provided downstream of the pump mechanism 604. Note that, in FIG. 2, only a tip portion of the hollow needle 60 (an end portion in the −Y direction) is illustrated. Also, the illustrated example illustrates a state where a liquid in a bag body 1 (e.g., an ink W in FIG. 2) has been drawn into the pump mechanism 604.

In the present embodiment, the control apparatus 601 is capable of rotating the screwdriver motor 602 by a predetermined angle and also rotating it in the reverse direction by the predetermined angle. In this way, the first dedicated tool 70 is rotatable in a first direction (e.g., clockwise direction) and in a second direction (e.g., a counterclockwise direction). The control apparatus 601 is also capable of driving the pump motor 603 to control a suction operation of drawing the liquid from the liquid container 200 into the pump mechanism 604. Also, in a case of executing a printing operation, the control apparatus 601 executes control for pumping the liquid drawn into the pump mechanism 604 to the print head 101. Moreover, in a case of executing control for circulating the liquid between the printing apparatus 100 and the liquid container 200 (described later), the control apparatus 601 executes control for pumping the liquid drawn into the pump mechanism 604 to the liquid container 200. Hereinafter, an operation of pumping the liquid from the pump mechanism 604 to the print head 101 and an operation of pumping the liquid from the pump mechanism 604 to the liquid container 200 will be referred to simply as “pumping operation” as appropriate in a case where they do not particularly need to be distinguished. In a case of executing a suction operation or a pumping operation, the opening and closing of the upstream on-off valve 605 and the downstream on-off valve 606 are controlled. Note that, in the present embodiment, a piston pump is used but a diaphragm pump, a tube pump, or the like may be used as another example. The hollow needle 60 is connected to the liquid supply tube 106 for the corresponding liquid's color to thereby form a channel to the main body of the printing apparatus 100. In the present embodiment, when the liquid container 200 is mounted to the liquid supply unit 105, the hollow needle 60 of the liquid supply unit 105 is inserted into the liquid supply hole 39 in the liquid container 200, and the first dedicated tool 70 in the liquid supply unit 105 is inserted into a dedicated tool hole 51. As the hollow needle 60 is inserted into the liquid supply hole 39, a first on-off valve 37 provided in the liquid supply hole 39 becomes opened. Note that the first on-off valve 37 is closed in the state where the hollow needle 60 is not inserted in the liquid supply hole 39.

Also, in the present embodiment, in a case where the liquid returns to the liquid container 200 from the printing apparatus 100, the liquid passes through a channel different from the channel through which to supply the liquid to the printing apparatus 100 from the liquid container 200 (e.g., the bypass channel unit to be described later). The channel through which the liquid flows to return to the liquid container 200 from the printing apparatus 100 is provided with an on-off valve that switches the open/closed state of the channel (e.g., the second on-off valve 43). In the present embodiment, in a case of moving this on-off valve, the first dedicated tool 70 included in the printing apparatus 100 is inserted into the dedicated tool hole 51 provided in the liquid container 200. Then, the first dedicated tool 70 moves the on-off valve to switch the open/closed state of the channel.

The liquid container 200 has the bag body 1 to contain the liquid to be supplied to the printing apparatus 100, and an outlet unit 2 for discharging the liquid in the bag body to the printing apparatus 100. The outlet unit 2 has a spout 20, which has a liquid inlet hole 31 into which the liquid in the bag body 1 flows in a case where the liquid in the bag body 1 is supplied to the printing apparatus 100, and a check valve 33 provided in the liquid inlet hole 31.

The spout 20 has a liquid channel 30 which is provided to continue from the liquid inlet hole 31, the liquid supply hole 39, which is provided to continue from the liquid channel 30 and in which the hollow needle 60 is inserted, and the first on-off valve 37, which is provided in the liquid supply hole 39. That is, the liquid inlet hole 31, the liquid channel 30, and the liquid supply hole 39 communicate with one another and form a single channel in a case of supplying the liquid in the bag body 1 to the printing apparatus 100. Hereinafter, the liquid inlet hole 31, the liquid channel 30, and the liquid supply hole 39 in a case of permitting a flow of the liquid from the bag body 1 to the printing apparatus 100 will be referred to collectively as “supply channel unit” as appropriate.

The spout 20 further has a bypass channel 40 which is provided so as to branch off from the liquid channel 30, a bypass outlet hole 41 into which the liquid having flowed through the bypass channel 40 flows out in a case where the liquid is to be filled into the bag body 1, and the second on-off valve 43, which is provided in the bypass outlet hole 41. In the case where the liquid is filled into the bag body 1, the liquid is returned into the bag body 1 through the liquid supply hole 39, the liquid channel 30, the bypass channel 40, and the bypass outlet hole 41. Hereinafter, the liquid supply hole 39, the liquid channel 30, the bypass channel 40, and the bypass outlet hole 41, which permit a flow of the liquid from the printing apparatus 100 back into the bag body 1, will be referred to collectively as “bypass channel unit” as appropriate. The spout 20 further has the dedicated tool hole 51 to insert the first dedicated tool 70, which opens and closes the second on-off valve 43.

### <Liquid Circulation>

Now, the liquid circulation in the present embodiment will be described. In the following, a case where the liquid contained in each liquid container 200 is an ink containing a pigment color material, which is a precipitating component, and a liquid medium in which this pigment color material is dispersed will be exemplarily described. In a case where the liquid container 200 is left at rest in the same posture for a long period of time, the pigment color material precipitates due to the effect of gravity. This results in a phenomenon in which the density of the color material in the liquid container 200 becomes non-uniform. The unevenness in the density of the precipitating component may lead to a failure to eject the liquid at a uniform density from the print head 101. Also, in a case where the liquid container 200 has been left at rest in the same posture for a long period of time for long-term storage or because it has not been used for a long time, the precipitation in the liquid may further progress at a lower portion of the liquid container 200. The liquid with the increased density has lower fluidity, which may make it difficult to supply the liquid stably at a uniform density. Also, in a case where the printing apparatus 100 has been left unused for a long period of time with the liquid left inside the printing apparatus 100, the liquid may fail to be ejected at a uniform density from the print head 101.

To solve such problems, it is desirable to circulate the liquid inside the liquid container 200 to make the density uniform and then supply the liquid to the printing apparatus 100. However, in the present embodiment, the liquid container 200 does not include a liquid circulation mechanism (e.g., a pump). For this reason, in the present embodiment, the liquid in the liquid container 200 is circulated by using the pump originally included in the printing apparatus 100 for supplying the liquid to the print head 101 and some channels.

First, the flow of the liquid in a case of executing a suction operation will be described. As a premise, the liquid container 200 is mounted to the liquid supply unit 105. That is, the hollow needle 60 included in the liquid supply unit 105 has been inserted in the liquid supply hole 39 included in the liquid container 200. Thus, the liquid supply hole 39 has already been opened. Also, at this point, the second on-off valve 43 in the bypass channel unit is closed. In a case of executing a suction operation, the control apparatus 601 included in the liquid supply unit 105 closes the downstream on-off valve 606 and opens the upstream on-off valve 605. Then, in this state, a negative pressure to draw the liquid in the bag body 1 into the pump mechanism 604 is generated. As a result, the check valve 33 provided in the liquid inlet hole 31 is sucked up but remains inside the liquid inlet hole 31. Thus, the supply channel unit in the liquid container 200 is opened. As the suction operation further continues, the liquid is supplied to the printing apparatus 100 through the supply channel unit.

Next, the flow of the liquid in a case of filling the liquid into the liquid container 200 from the printing apparatus 100 (i.e., returning the liquid) will be described. As a premise, the liquid has been drawn into the pump mechanism 604 by the above suction operation. In a case of executing a pumping operation, the negative pressure generated at the time of supplying the liquid to the printing apparatus 100 from the liquid container 200 is stopped. Moreover, the check valve 33 is in a state of closing the liquid inlet hole 31 with a biasing force from a first biasing member 32 (described later) provided in the liquid inlet hole 31. In a case of filling the liquid into the liquid container 200 from the printing apparatus 100, the first dedicated tool 70 opens the second on-off valve 43. In this state, the control apparatus 601 drives the pump motor 603 to execute control for pushing out the liquid in the pump mechanism 604. As a result, the liquid is sent to the liquid supply hole 39 included in the liquid container 200 through the hollow needle 60 included in the printing apparatus 100. Then, the liquid sent to the liquid sent to the liquid supply hole 39 is filled into the bag body 1 through the bypass channel unit. This concludes the description of the liquid circulation in the present embodiment.

### <Liquid Container 200>

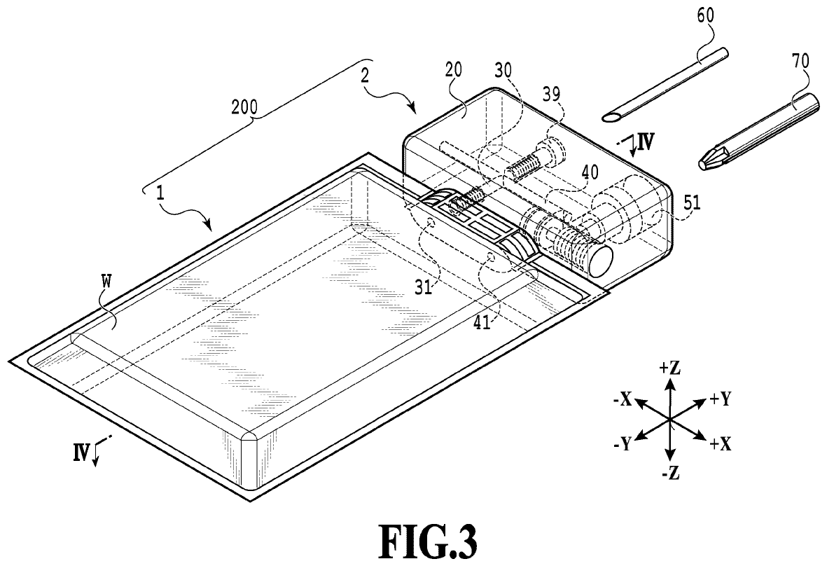

FIG. 3 is a transparent perspective view illustrating a schematic configuration of each liquid container 200 in the present embodiment. As illustrated in FIG. 3, the spout 20 included in the outlet unit 2 is provided at the end of the bag body 1 in the +Y direction. The bag body 1 contains a liquid therein. In the illustrated example, the bag body 1 is filled with the liquid. The bag body 1 is a flexible film formed into a bag shape by thermal welding or the like. The bag body 1 is preferably in a shape that becomes close to flat in a state where the liquid is used up. Examples of the shape of the bag body 1 include a pillow type, a three-way type, a gusset type, and the like. On the inner side of the flexible film is formed a liquid contact layer of a thermoplastic resin (e.g., polyethylene or the like) that has wettability against the liquid and has good thermal weldability. On the outer side of the flexible film is formed a gas barrier layer obtained by laminating multiple layers with low gas permeability (e.g., multiple aluminum layers or the like). For example, the aluminum layers are laminated in the form of a film by vapor deposition or lamination. The film does not necessarily have to be of a multi-layer type. For example, the film may be of a single-layer resin type for applications where gas barrier properties are not highly important.

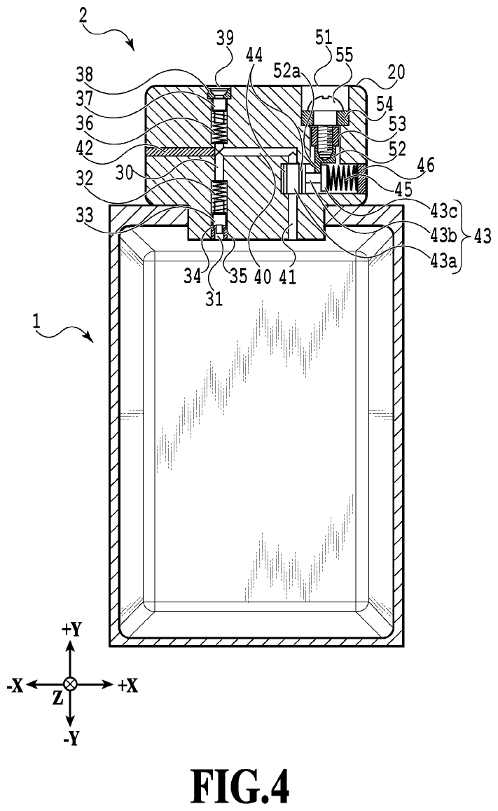

FIG. 4 is a schematic cross-sectional view along the IV-IV line in FIG. 3. As illustrated in FIG. 4, the spout 20 of the outlet unit 2 has a first sealing member 34, a first spacer 35, a second biasing member 36 (e.g., a compression spring), and a second sealing member 38 as well as the above-described components. The spout 20 further has a first plug 42, O-rings 44, a third biasing member 45 (e.g., a compression spring), a second plug 46, an eccentric pin 52, a nut 53, a second spacer 54, and a stepped bolt 55.

The spout 20 is a molded component and is made by assembling multiple components. After the illustrated components are assembled, the spout 20 is connected to the bag body 1 in an airtight manner by thermal welding. The constituent material of the spout 20 preferably contains a material that has wettability against the liquid and has good thermal weldability and moldability. For example, the constituent material of the spout 20 preferably contains polyethylene, polypropylene, or the like. Also, for a similar reason, the constituent material of the check valve 33, the first on-off valve 37, the second on-off valve 43, the first plug 42, or the first spacer 35 preferably contains polyethylene, polypropylene, or the like. Also, at least the welding surfaces of the bag body 1, the spout 20, the first plug 42, and the first spacer 35 are preferably made of the same material considering the thermal weldability between the components. The constituent components of the outlet unit 2 do not necessarily have to be processed by molding. For example, the constituent components of the outlet unit 2 may be processed by another processing method such as cutting. Similarly, considering the wettability against the liquid and corrosion resistance, the constituent materials of the first biasing member 32 (e.g., a compression spring) and the second biasing member 36 preferably contain stainless steel. Also, the constituent materials of the first sealing member 34, the second sealing member 38, and the O-rings 44 preferably contain a rubber material or a thermoplastic elastomer. Examples include ethylene propylene rubber (EPDM), hydrogenated nitrile rubber (H-NBR), and the like.

### <Supply Channel Unit>

The first biasing member 32, the check valve 33, the first sealing member 34, and the first spacer 35 are inserted in the liquid inlet hole 31. The check valve 33 is constantly biased by the first biasing member 32 to be in contact with the first sealing member 34. The first sealing member 34 is formed integrally with the first spacer 35 by rubber lining, bonding, or the like. Further, by being fixed to the spout 20, the first spacer 35 is provided so as not to fall when biased by the first biasing member 32. Incidentally, examples of the method of fixing the first spacer 35 to the spout 20 include press fitting, bonding, welding, and the like. With this configuration, the check valve 33 is in contact with the first sealing member 34 by the biasing force from the first biasing member 32 in a state where no external force is applied to the check valve 33, thereby maintaining a state of closing the liquid inlet hole 31. This prevents air from flowing into the bag body 1 and the liquid from flowing back into the bag body 1 in the state where no external force is applied to the check valve 33. In a case where the check valve 33 in this state receives an external force that moves the check valve 33 from a position for closing the liquid inlet hole 31 in such a direction as to open the liquid inlet hole 31, the check valve 33 is moved in the +Y direction while flexing the first biasing member 32. That is, the liquid inlet hole 31 become opened. In the present embodiment, during a suction operation, the check valve 33 moves from the position for closing the liquid inlet hole 31 in such a direction as to open the liquid inlet hole 31 (the +Y direction). After the suction operation, the check valve 33 moves from a position for opening the liquid inlet hole 31 in such a direction as to close it (the −Y direction) with the elastic restoring force of the first biasing member 32. As a result, the liquid inlet hole 31 returns to the closed state again.

The liquid channel 30 is a channel in the spout 20 provided between and communicating with the liquid inlet hole 31, which is provided so as to communicate with the inside of the bag body 1, and the liquid supply hole 39, which is provided so as to communicate with the outside of the liquid container 200. The width of the liquid channel 30 is narrower than the widths of the liquid inlet hole 31 and the liquid supply hole 39. In this way, the first biasing member 32 can be fixed to the step between the liquid inlet hole 31 and the liquid channel 30. Likewise, the second biasing member 36 can be fixed to the step between the liquid supply hole 39 and the liquid channel 30.

The second biasing member 36, the first on-off valve 37, and the second sealing member 38 are inserted in the liquid supply hole 39. The first on-off valve 37 is constantly in contact with the second sealing member 38 by a biasing force from the second biasing member 36. By being fixed to the spout 20, the second sealing member 38 is provided so as not to fall due to the biasing force from the second biasing member 36. Incidentally, examples of the method of fixing the second sealing member 38 to the spout 20 include rubber lining, bonding, and the like. Also, to prevent the second sealing member 38 from falling from the liquid supply hole 39, another member, such as a film, may be welded to the opening of the liquid supply hole 39. Such a configuration improves gas barrier performance and prevents inclusion of foreign substances from the outside as compared to a case of not welding another member. Also, the first on-off valve 37 is in contact with the second sealing member 38 by the biasing force from the second biasing member 36 in a state where no external force is applied to the first on-off valve 37, thereby maintaining a state of closing the liquid supply hole 39.

Accordingly, the liquid will be prevented from leaking through the liquid supply hole 39 even in a case where a pressure is applied from the inside of the bag body 1 toward the outside, such as a case where the user drops the liquid container 200 or strongly holds the bag body 1.

### <Bypass Channel Unit>

The outlet unit 2 has the bypass channel unit, which is provided so as to bypass the liquid inlet hole 31 provided with the check valve 33. The bypass channel 40 provided in the outlet unit 2 branches off from the liquid channel 30 in the +X direction to bypass the check valve 33 and be connected to the end of the bypass outlet hole 41 in the +Y direction. The end of the bypass outlet hole 41 in the −Y direction communicates with the inside of the bag body 1. With this configuration, the liquid supply hole 39, the liquid channel 30, the bypass channel 40, and the bypass outlet hole 41 communicate with one another in the bypass channel unit. Incidentally, since the spout 20 is molded, a hole is formed which extends from the liquid channel 30 in the direction opposite to the direction in which the bypass channel 40 is formed, and which communicates with the side surface of the spout 20 in the −X direction. Here, this hole is tightly closed by the first plug 42, and is therefore not particularly problematic.

Also, a space to accommodate the second on-off valve 43 and the third biasing member 45 fixed to the second on-off valve 43 is provided at a position in a direction orthogonal to the bypass outlet hole 41 extending in the Y direction (i.e., the X direction). While this space is formed so as to communicate with the side surface of the spout 20 in the +X direction, the end of this space in the +X direction (i.e., an opening) is tightly closed by the second plug 46. Incidentally, examples of the method of fixing the second plug 46 to the spout 20 include press fitting, bonding, welding, and the like. This prevents the third biasing member 45 from falling from the opening provided in the side surface of the spout 20.

The second on-off valve 43 is biased by the third biasing member 45 so as to be located at a position for closing the bypass channel unit. Moreover, the second on-off valve 43 is configured to be movable from the position for closing the bypass channel unit to a position for opening the bypass channel unit against the biasing by the third biasing member 45 by the first dedicated tool 70 for moving the second on-off valve 43.

The second on-off valve 43 includes a piston head portion 43a, a body portion 43b, and a flat plate portion 43c. The piston head portion 43a is located over the bypass outlet hole 41 in a state where no external force is applied to the second on-off valve 43. Further, a single groove that completely encircles the piston head portion 43a in the Y direction is provided at each of its end in the −X direction and its end in the +X direction. An O-ring 44 is fitted in each groove. In this way, in a case where the piston head portion 43a closes the bypass outlet hole 41, the O-rings 44 seal the gap between the bypass outlet hole 41 the space accommodating the second on-off valve 43, etc. and thereby improve the airtightness of the bypass outlet hole 41. The body portion 43b is formed so as to continue from the piston head portion 43a in the +X direction. The flat plate portion 43c is formed so as to continue from the end of the body portion 43b in the +X direction. The third biasing member 45 is fixed to the surface of the flat plate portion 43c opposite from its surface on which the body portion 43b is formed. The end of the third biasing member 45 opposite from its end in contact with the flat plate portion 43c is in contact with the second plug 46. With this configuration, in the state where no external force is applied to the second on-off valve 43, the second on-off valve 43 is pushed by the biasing force from the third biasing member 45 in the −X direction and constantly closes the bypass outlet hole 41. That is, the bypass channel unit is constantly closed in the state where no external force is applied to the second on-off valve 43.

In a case where an external force is applied which moves the second on-off valve 43 in the +X direction from this state, the bypass channel unit gets opened. In the present embodiment, the first dedicated tool 70 included in the printing apparatus 100 is inserted into the dedicated tool hole 51 included in the liquid container 200. Then, the first dedicated tool 70 moves the second on-off valve 43 to open the bypass channel unit. The eccentric pin 52, the nut 53, the second spacer 54, and the stepped bolt 55 are inserted in the dedicated tool hole 51. In the present embodiment, as the stepped bolt 55 is rotated by the first dedicated tool 70, the eccentric pin 52 is rotated as well. As the eccentric pin 52 is rotated, a protruding portion 52a of the eccentric pin 52 pushes the flat plate portion 43c in the +X direction. As a result, an external force that moves the piston head portion 43a in the +X direction is applied, thereby opening the bypass outlet hole 41. That is, the bypass channel unit is opened.

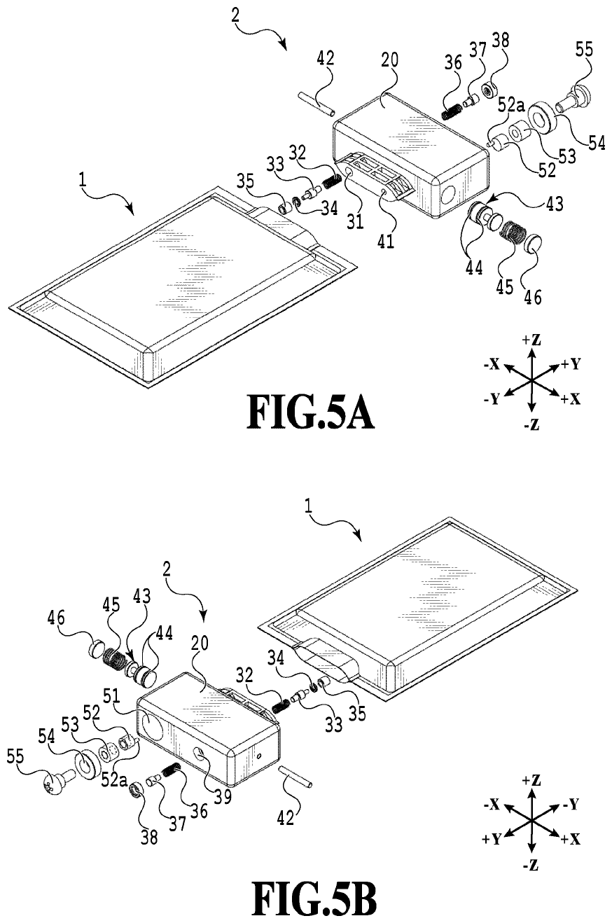

FIGS. 5A and 5B are schematic exploded perspective views of the liquid container 200 in the present embodiment. FIG. 5A is an exploded perspective view of the liquid container 200 as seen from the back side. FIG. 5B is an exploded perspective view as seen from the front side. As illustrated in FIG. 5B, the spout 20 is provided with the dedicated tool hole 51 to insert the first dedicated tool 70 included in the liquid supply unit 105.

The eccentric pin 52 and the nut 53 to be inserted in the dedicated tool hole 51 are tapped in their centers. This prevents loosening of the stepped bolt 55, which is to be screwed into the nut 53, and also enables attachment to the stepped bolt 55 at any angle. The diameter of the stepped portion of the stepped bolt 55 is slightly smaller than the inner diameter of the second spacer 54, which has an annular shape. In this way, the stepped bolt 55 can be freely rotated relative to the second spacer 54. The second spacer 54 is fixed to the dedicated tool hole 51 to be kept from falling from the dedicated tool hole 51. Examples of the method of fixing the second spacer 54 to the dedicated tool hole 51 include press fitting, bonding, welding, and the like.

Incidentally, the shape of the recess provided in the head of the stepped bolt 55 is preferably a somewhat special shape, instead of the typical cross-recessed shape. This is to prevent the stepped bolt 55 from being rotated by an unintended operation. Examples of the shape of the recess include a hexalobular shape, a pin with a cross hole, and the like. Hereinafter, the stepped bolt 55, the nut 53, and the eccentric pin 52 will be referred to collectively as “rotation mechanism” as appropriate.

In the present embodiment, the outlet unit 2 has the rotation mechanism, which is rotated by the first dedicated tool 70. In a case where the rotation mechanism is rotated in the first direction (e.g., the clockwise direction) by the first dedicated tool 70, the second on-off valve 43 is moved from the position for closing the bypass channel unit to the position for opening the bypass channel unit. Conversely, in a case where the rotation mechanism is rotated in the second direction (e.g., the counterclockwise direction), which is the opposite direction from the first direction, by the first dedicated tool 70, the second on-off valve 43 is moved from the position for opening the bypass channel unit to the position for closing the bypass channel unit.

The eccentric pin 52 included in the rotation mechanism has the protruding portion 52a at a position that is eccentric relative to the rotation axis of the rotation mechanism. The protruding portion 52a is provided so as to contact the surface of the flat plate portion 43c on which the body portion 43b is provided. As the stepped bolt 55 is rotated by the first dedicated tool 70, the eccentric pin 52 is rotated along with the stepped bolt 55. As a result, an external force that moves the piston head portion 43a of the second on-off valve 43 from a position for closing the bypass outlet hole 41 to a position for opening it is applied to the flat plate portion 43c.

Note that the first dedicated tool 70 is preferably a tool capable of performing an operation of rotating the rotation mechanism half a turn (i.e., a 180° rotation) with high reproducibility.

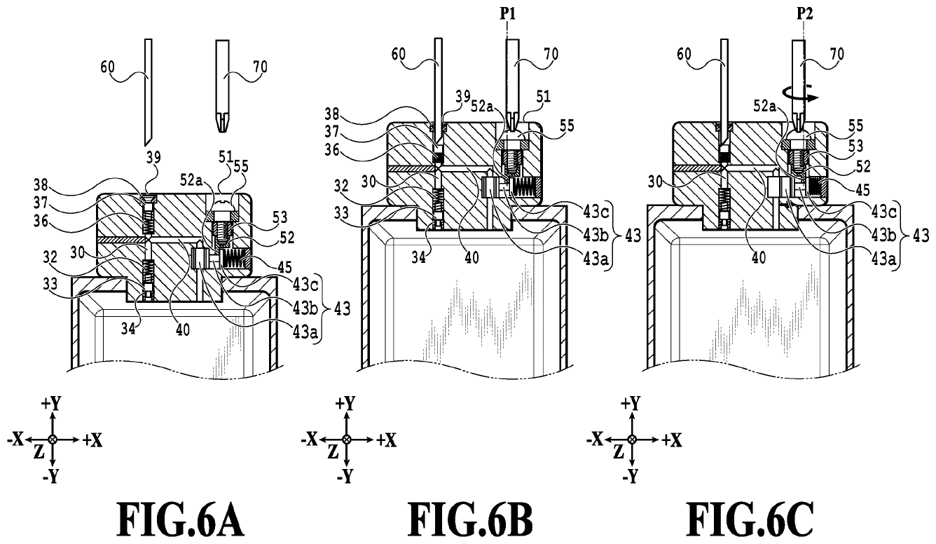

FIGS. 6A to 6C are schematic cross-sectional views explaining the opening and closing of the bypass channel unit in the present embodiment.

FIG. 6A is a view illustrating a state before the liquid container 200 is mounted to the printing apparatus 100. As illustrated in FIG. 6A, at a point before the liquid container 200 is mounted to the printing apparatus 100, the check valve 33 is in contact with the first sealing member 34 by the biasing force from the first biasing member 32, thereby closing the liquid inlet hole 31. Also, at this point, the second on-off valve 43 is biased by the third biasing member 45. As a result, the bypass channel unit is closed. Hereinafter, the position at which the second on-off valve 43 closes the bypass channel unit will be referred to as “first position” as appropriate.

FIG. 6B is a view illustrating a state after the liquid container 200 is mounted to the printing apparatus 100. Suppose that the user mounts the liquid container 200 to a tray 108 and moves the tray 108 forward in the +Y direction in this state. As a result, the liquid container 200 is mounted to the liquid supply unit 105. At this time, the hollow needle 60 is inserted into the liquid supply hole 39. Here, the hollow needle 60 is inserted in such a manner as to maintain airtightness from the outside with the second sealing member 38. At the same time, the hollow needle 60 pushes down the first on-off valve 37 in the −Y direction while flexing the second biasing member 36. As a result, the liquid supply hole 39 is opened.

Meanwhile, the first dedicated tool 70 is inserted into the dedicated tool hole 51. As the first dedicated tool 70 is inserted into the dedicated tool hole 51, the tip of the first dedicated tool 70 (e.g., a screwdriver bit accompanying a powered screwdriver) gets connected to the recess in the stepped bolt 55. Incidentally, in this state, the bypass channel unit is still closed.

In this state, the pump mechanism 604 performs a suction operation, thereby generating a negative pressure. This negative pressure moves the check valve 33 from the position for closing the liquid inlet hole 31 in such a direction as to open it while flexing the first biasing member 32 in the liquid inlet hole 31. Here, the liquid supply hole 39 is also opened. As a result, the supply channel unit is opened, so that the liquid is supplied to the liquid supply unit 105 from the liquid container 200.

FIG. 6C is a view illustrating a state where the bypass channel unit is getting opened. In the present embodiment, the screwdriver motor 602 included in the liquid supply unit 105 rotates such that the first dedicated tool 70 rotates half a turn in the direction indicated by the arrow in FIG. 6C. Also, in conjunction with the rotation of the first dedicated tool 70, the rotation mechanism also rotates half a turn in the direction indicated by the arrow in FIG. 6C. That is, the stepped bolt 55, the nut 53, and the eccentric pin 52 rotate half a turn in the direction indicated by the arrow in FIG. 6C. As the rotation mechanism rotates, the protruding portion 52a of the eccentric pin 52 pushes the second on-off valve 43 toward the outside of the outlet unit 2 from its inside. As a result, the piston head portion 43a of the second on-off valve 43 moves to the position for opening the bypass outlet hole 41 from the position for closing it. Hereinafter, the position at which the second on-off valve 43 opens the bypass channel unit will be referred to as “second position” as appropriate. In this state, the pump mechanism 604 included in the liquid supply unit 105 pushes the liquid out. As a result, the liquid is pumped to the liquid container 200 from the liquid supply unit 105. At this time, the liquid inlet hole 31 is closed by the check valve 33. Thus, when the liquid is returned to the liquid container 200 from the liquid supply unit 105, the liquid is filled into the bag body 1 through the bypass channel unit (that is, the liquid is circulated).

Also, in a case where the rotation mechanism is rotated in the second direction, which is the reverse of the first direction, by the first dedicated tool 70, the second on-off valve 43 is returned to the first position from the second position. Specifically, in a case of supplying the liquid to the printing apparatus 100 from the bag body 1 of the liquid container 200, the second on-off valve 43 returns to the first position from the second position with the elastic restoring force of the third biasing member 45. Incidentally, it is needless to say that the rotation mechanism is not limited to the above configuration and may employ, for example, a configuration that performs an opening/closing operation by continuously rotating in the first direction.

For example, it is needless to say that an operation of rotating the rotation mechanism from 0° to 180° and further rotating the rotation mechanism forward by 180° from this state (i.e., rotating the rotation mechanism 360° by rotating it 180° twice in the same direction) may be performed. Specifically, it is needless to say that, first, the rotation mechanism may be rotated 180° from the state of closing the second on-off valve 43 to the state of opening the second on-off valve 43, and then further rotated forward by 180° from the state of opening the second on-off valve 43 to be brought back to the state of closing the second on-off valve 43 again.

One example of a specific mechanism capable of implementing such an operation is, for example, a mechanism that uses a servomotor as the screwdriver motor 602, for example, and utilizes the servomotor's continuous rotation function to continuously rotate in the first direction.

### CONCLUSION

As described above, in the state where no external force is applied to the check valve 33 in the present embodiment, the check valve 33 closes the supply channel unit. Thus, even if the first on-off valve 37, which is provided on a farther side in the supply channel unit from the bag body 1 than is the check valve 33, is opened, the degree of deaeration and the degree of cleanness of the liquid contained in the bag body 1 will be maintained.

The liquid circulation in the present embodiment is aimed at making the density of the liquid inside the bag body 1 uniform and then supplying the liquid to the printing apparatus 100, and at returning the liquid whose pigment has precipitated inside the printing apparatus 100 due to being left unused for a long period of time back into the bag body 1. If the liquid container 200 includes the supply channel unit and does not include the bypass channel unit, the supply channel unit cannot return the liquid to the liquid container 200 from the printing apparatus 100 since the supply channel unit includes the check valve 33. That is, the liquid cannot be circulated. The outlet unit 2 in the present embodiment is provided with the bypass channel unit in order to circulate the liquid. In the present embodiment, the bypass channel unit can be used to circulate the liquid between the liquid container 200 and the printing apparatus 100. Thus, in a case where the pigment contained in the liquid aggregates or precipitates, for example, circulating the liquid will a deterioration in the printing quality in a printing operation and the like. Here, in order to prevent the second on-off valve 43, which switches the opening and closing of the bypass channel unit, from being opened or closed by mistake, the first dedicated tool 70 included in the printing apparatus 100 is used to open and close the bypass channel unit. This reduces the possibility of the user opening the second on-off valve 43 by mistake and lowering the degree of deaeration and the degree of cleanness of the liquid.

Further, even in a case where the second on-off valve 43 is opened for some reason, the second on-off valve 43 will be closed by the elastic restoring force of the third biasing member 45 if in a state where no external force is applied. This reduces the possibility of the second on-off valve 43 being opened by mistake.

Further, while the liquid is returned to the liquid container 200 from the printing apparatus 100, the first dedicated tool 70 is maintained in the state of being connected to the recess in the stepped bolt 55 included in the rotation mechanism. Accordingly, the protruding portion 52a included in the rotation mechanism is also maintained in the state of pushing the flat plate portion 43c. That is, the flat plate portion 43c of the second on-off valve 43 is maintained in the state of being pushed by the protruding portion 52a, thereby preventing the second on-off valve 43 from being closed by mistake while the liquid is returned to the liquid container 200 from the printing apparatus 100.

Hence, the liquid container 200 according to the present embodiment is capable of stably opening and closing its valve element in a case of filling a liquid into the liquid container 200.

### Second Embodiment

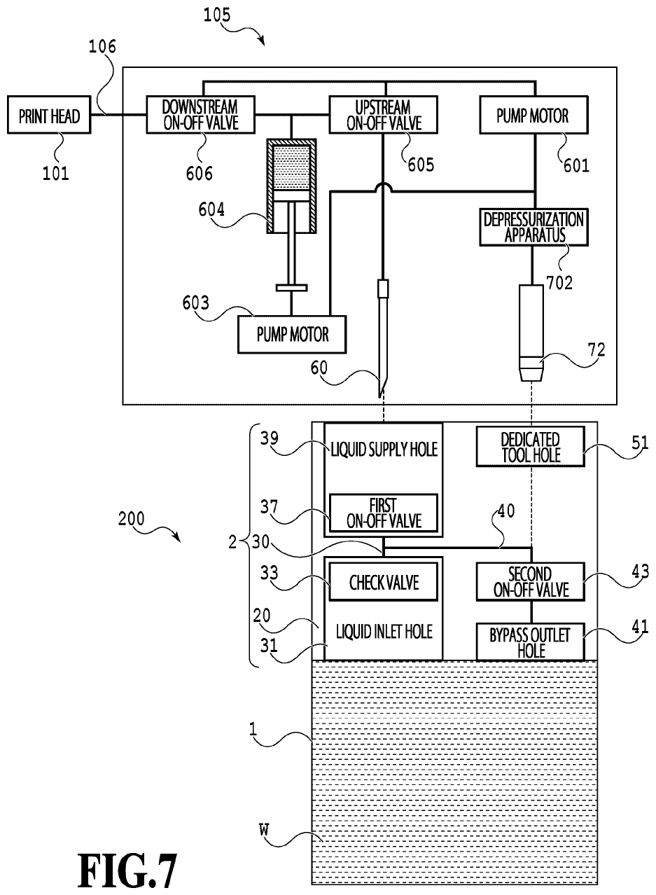

A second embodiment is aimed at providing a liquid container having a more reliable valve element. Referring to FIGS. 7 to 9, description of components similar to those in the first embodiment will be omitted using the same reference signs, and the difference from the first embodiment will be mainly described.

### <Channels in Whole System>

FIG. 7 is a schematic diagram illustrating channels in a whole system in the present embodiment. As illustrated in FIG. 7, in the present embodiment, the liquid supply unit 105 has a depressurization apparatus 702 (e.g., a vacuum ejector, a vacuum pump, or the like) and a second dedicated tool 72 (e.g., a suction nozzle provided at the tip of the depressurization apparatus 702). The second dedicated tool 72 generates a negative pressure by sucking the air in a space which a surface of the second on-off valve 43 and the atmosphere communicate with to thereby move the second on-off valve 43 to the second position from the first position. As a result, the bypass channel unit is opened.

### <Liquid Container 200>

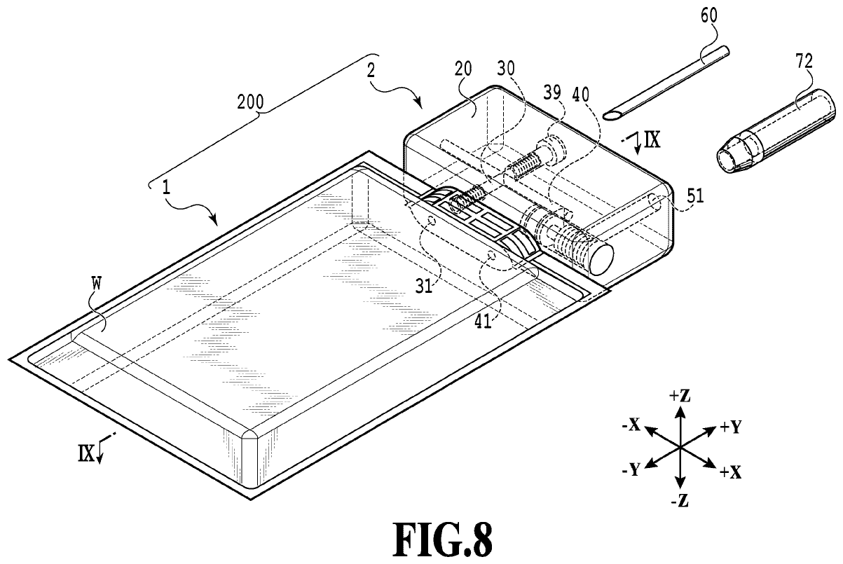

FIG. 8 is a transparent perspective view illustrating a schematic configuration of each liquid container 200 in the present embodiment. The second dedicated tool 72 illustrated in FIG. 8 is only a tip portion of the second dedicated tool 72. The second dedicated tool 72 sticks to a peripheral edge portion of the opening of the dedicated tool hole 51 in an airtight manner. The material of a tip portion of the second dedicated tool 72 preferably contains an elastic material. This is because, in a case where the tip portion of the second dedicated tool 72 is pressed against the peripheral edge portion of the opening of the dedicated tool hole 51, the tip portion undergoes elastic deformation, which makes it easier to ensure airtightness between the tip portion and the opening portion of the dedicated tool hole 51. For example, the constituent material of the tip portion of the second dedicated tool 72 preferably contains urethane rubber or the like.

The internal structure of each liquid container 200 in the present embodiment will now be described. The components mounted to the channels in the spout 20 are substantially the same as those in the first embodiment. However, the shape of the second on-off valve 43 and the configuration of the third biasing member 45 are different from those in the first embodiment.

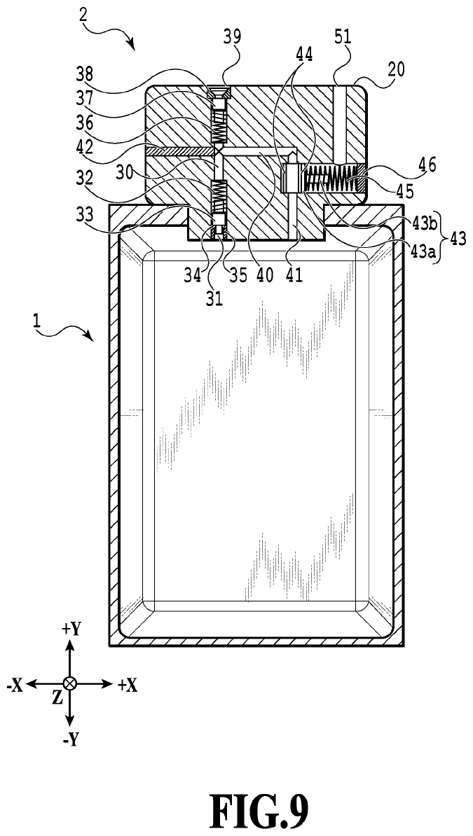

FIG. 9 is a schematic cross-sectional view along the IX-IX line in FIG. 8. As illustrated in FIG. 9, in the present embodiment, the second on-off valve 43 does not have the flat plate portion 43c described above. Also, in the present embodiment, the hardness of the third biasing member 45 is lower than the third biasing member 45 in the first embodiment. In the present embodiment, the second on-off valve 43 is designed to move to the second position from the first position in a case where the vacuum pressure in the space accommodating the third biasing member 45 falls below a predetermined value. Also, in the present embodiment, the liquid container 200 does not have the rotation mechanism. That is, the configuration of the dedicated tool hole 51 is such that it communicates with the space accommodating the third biasing member 45.

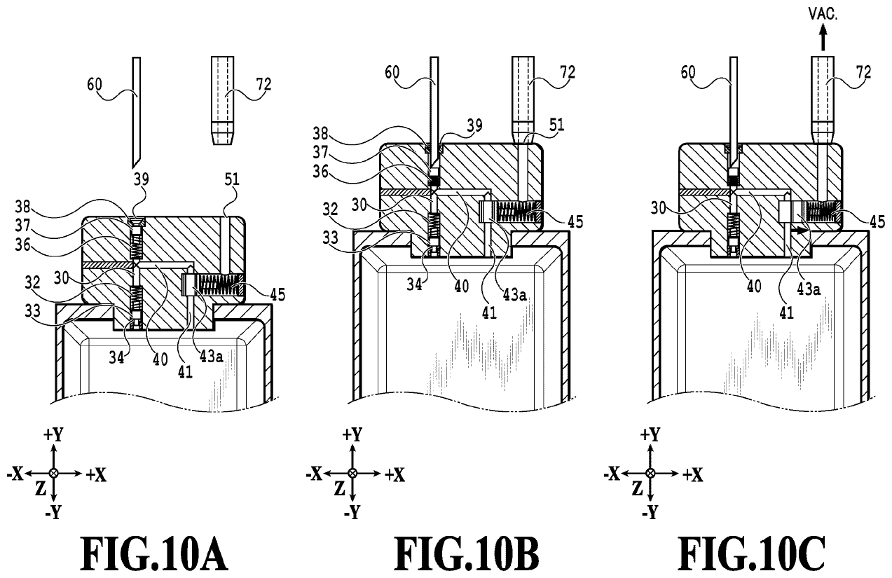

FIGS. 10A to 10C are schematic cross-sectional views explaining the opening and closing of the bypass channel unit in the present embodiment. FIG. 10A is a view illustrating a state before the liquid container 200 is mounted to the printing apparatus 100. At this point, as in the first embodiment, the check valve 33 is biased by the first biasing member 32 to thereby close the liquid inlet hole 31. The first on-off valve 37 is biased by the second biasing member 36 to thereby close the liquid supply hole 39. The second on-off valve 43 is biased by the third biasing member 45 such that the piston head portion 43a of the second on-off valve 43 is located at the position for closing the bypass outlet hole 41. That is, the supply channel unit and the bypass channel unit are closed.

FIG. 10B is a view illustrating a state after the liquid container 200 is mounted to the printing apparatus 100. In the present embodiment too, the liquid container 200 is mountable to the liquid supply unit 105. In the present embodiment, the second dedicated tool 72 comes into contact with the opening portion of the dedicated tool hole 51. As a result, a channel inside the second dedicated tool 72 and the space accommodating the third biasing member 45 communicate with each other through the dedicated tool hole 51. Note that, in this state, the depressurization apparatus 702 is not yet driven, so that the bypass channel unit is closed.

FIG. 10C is a view illustrating a state where the bypass channel unit is opened. In a case where the depressurization apparatus 702 is driven with the second dedicated tool 72 in contact with the peripheral edge portion of the opening of the dedicated tool hole 51, the air inside the dedicated tool hole 51 and the space accommodating the third biasing member 45 is sucked. That is, the air is sucked in the direction indicated by the arrow “VAC” in FIG. 10C. This suction causes the second on-off valve 43 to move toward the second position from the first position while flexing the third biasing member 45. As a result, the bypass channel unit in the present embodiment is opened.

Also, by stopping the air suction with the depressurization apparatus 702 and releasing the space accommodating the third biasing member 45 to the atmosphere, the second on-off valve 43 returns to the first position from the second position with the elastic restoring force of the third biasing member 45. As a result, the bypass channel unit is closed again.

As described above, in the present embodiment, the second on-off valve 43 moves to the second position from the first position by the air suction. With this configuration, the number of components used to move the second on-off valve 43 is smaller than that in the first embodiment. That is, the possibility of a component experiencing a failure is reduced. Accordingly, with the configuration in the present embodiment, it is possible to provide a liquid container 200 having a more reliable valve element.

### Third Embodiment

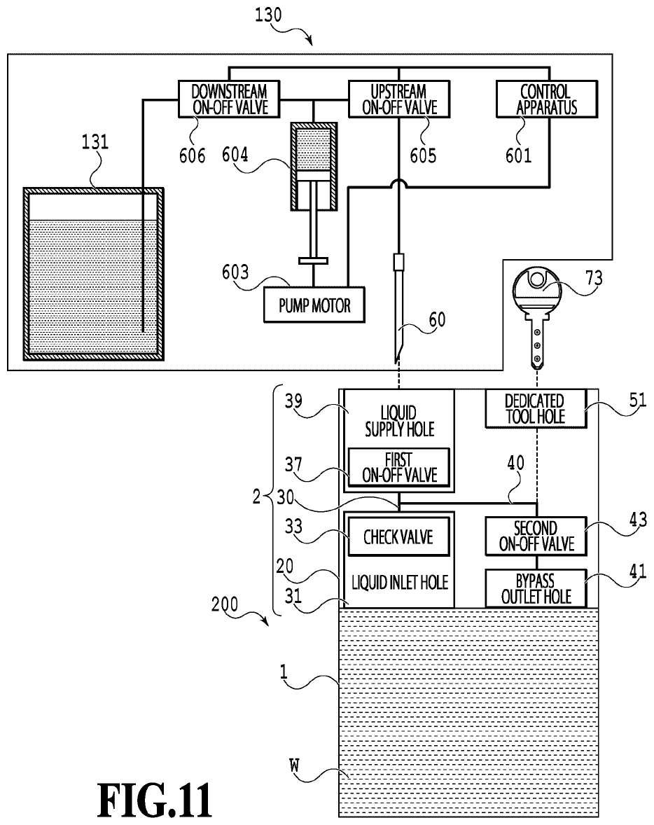

A third embodiment is aimed at providing a technique capable of reducing the possibility of an on-off valve of a liquid container 200 being opened or closed by mistake even at the stage of manufacturing the liquid container 200. Referring to FIGS. 11 to 14C, description of components similar to those in the first embodiment will be omitted using the same reference signs, and the difference from the first embodiment will be mainly described.

In the first and second embodiments, a liquid is circulated between the printing apparatus 100 and the liquid container 200. On the other hand, in the present embodiment, at the stage of manufacturing the liquid container 200, the liquid is circulated between a manufacturing apparatus 130 for the liquid container 200 (e.g., a liquid filling apparatus) and the liquid container 200. Note that the description in the present embodiment is not intended to limit the scopes of application of the first and second embodiments.

### <Channels in Whole System>

FIG. 11 is a schematic diagram illustrating channels in a whole system in the present embodiment. As illustrated in FIG. 11, the system in the present embodiment includes the manufacturing apparatus 130 and the liquid container 200. The manufacturing apparatus 130 has a liquid tank 131 storing the liquid to be filled into the liquid container 200. In the present embodiment, the operator of the manufacturing apparatus 130 inserts a third dedicated tool 73 (e.g., a key) into a key cylinder 56 (described later) provided in the dedicated tool hole 51 and rotates the third dedicated tool 73 to move the second on-off valve 43. For example, the third dedicated tool 73 is preferably a dimple key or the like. This is to keep the user from easily unlocking and locking the liquid container 200 after it is manufactured.

Also, in the present embodiment, in a case of recycling the liquid container 200, for example, it is supplied to the liquid tank 131 of the manufacturing apparatus 130. Also, in a case of manufacturing the liquid container 200, for example, the liquid is filled into the liquid container 200 from the liquid tank 131.

### <Liquid Container 200>

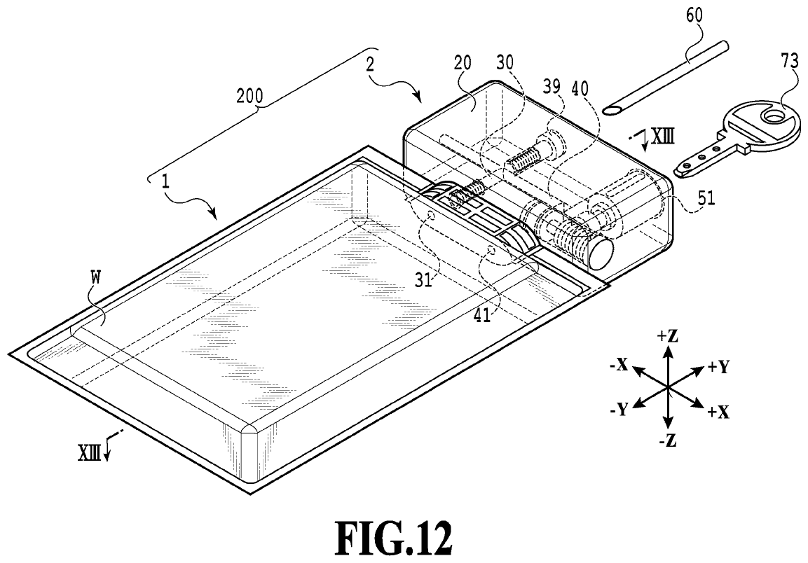

FIG. 12 is a transparent perspective view illustrating a schematic configuration of each liquid container 200 in the present embodiment.

As illustrated in FIG. 12, in the present embodiment, the third dedicated tool 73 is inserted into the dedicated tool hole 51.

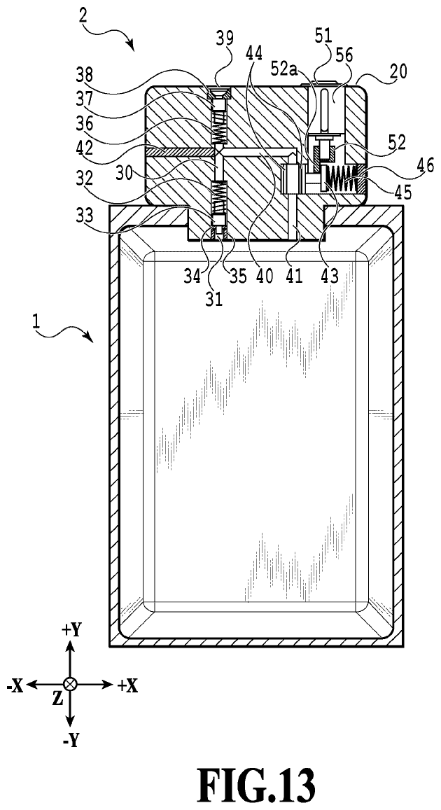

FIG. 13 is a schematic cross-sectional view along the XIII-XIII line in FIG. 12. The internal structure of the liquid container 200 will now be described. In the first embodiment, the rotation mechanism includes the stepped bolt 55, the nut 53, and the eccentric pin 52. In the present embodiment, however, the rotation mechanism includes the key cylinder 56 and the eccentric pin 52.

The key cylinder 56 has a keyhole corresponding to the shape of the third dedicated tool 73. The key cylinder 56 also has an outer tube and an inner tube. In the present embodiment, the key cylinder 56 and the eccentric pin 52 are inserted in the dedicated tool hole 51. The outer tube of the key cylinder 56 is fixed to the inner side of the dedicated tool hole 51. Examples of the method of fixing the key cylinder 56 to the inner side of the dedicated tool hole 51 include press fitting, bonding, screwing, and the like. Also, the eccentric pin 52 is fixed to an end of the inner tube of the key cylinder 56. Examples of the method of fixing the eccentric pin 52 to an end of the inner tube of the key cylinder 56 include press fitting, bonding, screwing, and the like. The inner tube of key cylinder 56 can be rotated relative to the outer tube only by the third dedicated tool 73, which has a shape corresponding to the shape of the keyhole included in the key cylinder 56. Also, each of the multiple liquid containers 200 is provided with a different combination of a key cylinder 56 and a third dedicated tool 73. However, it is preferable that there exists a master key which can unlock all key cylinders 56. This is because the third dedicated tool 73 may be lost.

In the present embodiment, in a case where the operator rotates the third dedicated tool 73 inserted in the keyhole of the key cylinder 56, the inner tube of the key cylinder 56 rotates as well. As the inner tube of the key cylinder 56 rotates, the eccentric pin 52 connected to the tip of the inner tube of the key cylinder 56 rotates as well. For example, the eccentric pin 52 rotates half a turn, as in the first embodiment. As the eccentric pin 52 rotates half a turn, the protruding portion 52a pushes the flat plate portion 43c toward the outside of the spout 20 from its inside, as in the first embodiment. As a result, the second on-off valve 43 moves to the second position from the first position, as in the first embodiment.

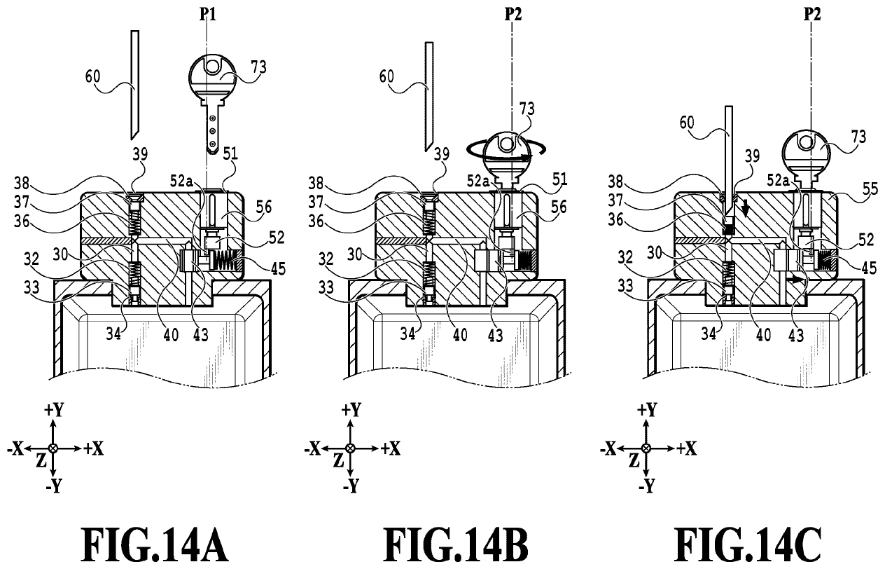

FIGS. 14A to 14C are schematic cross-sectional views explaining the opening and closing of the bypass channel unit in the present embodiment. FIG. 14A is a view illustrating a state before the hollow needle 60 and the third dedicated tool 73 are inserted in the liquid container 200. In the present embodiment, first, the liquid container 200 is mounted at a predetermined position on or in the manufacturing apparatus 130. As a result, the liquid container 200 is positioned in a predetermined posture. At this point, the hollow needle 60 and the third dedicated tool 73 are not yet inserted in the liquid container 200, as in the first embodiment. Thus, the channels in the liquid container 200 are still closed.

FIG. 14B is a view illustrating a state after the third dedicated tool 73 is inserted into the liquid container 200. In the present embodiment, the operator mounts the liquid container 200 at the predetermined position on or in the manufacturing apparatus 130, and then unlocks the key cylinder 56 with the third dedicated tool 73 prior to inserting the hollow needle 60 into the liquid supply hole 39. Suppose that the third dedicated tool 73 is inserted into the keyhole of the key cylinder 56 as illustrated in FIG. 14B. In the present embodiment, in a case where the operator rotates the third dedicated tool 73 inserted in the keyhole of the key cylinder 56 half a turn, the cylinder lock in the present embodiment gets unlocked. As the inner tube of the key cylinder 56 rotates half a turn, the eccentric pin 52 connected to the tip of the inner tube of the key cylinder 56 rotates half a turn as well. At this time, the protruding portion 52a pushes the flat plate portion 43c toward the outside of the spout 20 from its inside, as in the first embodiment. As a result, the entire second on-off valve 43 moves to the second position from the first position while flexing the third biasing member 45. As the second on-off valve 43 moves to the second position from the first position, the bypass channel unit gets opened. Incidentally, in this state, the supply channel unit is still closed.

FIG. 14C is a view illustrating a state after the hollow needle 60 is inserted into the liquid container 200. In the present embodiment, the operator activates the manufacturing apparatus 130 after unlocking the cylinder lock. In response to the activation of the manufacturing apparatus 130, the hollow needle 60 included in the manufacturing apparatus 130 is inserted into the liquid supply hole 39 in the liquid container 200. As the hollow needle 60 is inserted into the liquid supply hole 39, the liquid supply hole 39 gets opened, as in the first embodiment. In this state, a suction operation and a pumping operation from the manufacturing apparatus 130 to the liquid container 200 can be repeated to circulate the liquid between the manufacturing apparatus 130 and the liquid container 200. That is, in the present embodiment, it is possible to fill the liquid into the liquid container 200 from the manufacturing apparatus 130 and also supply the liquid to the manufacturing apparatus 130 from the liquid container 200.

In a case where the operator rotates the cylinder lock in the direction opposite to the direction for unlocking the cylinder lock to thereby lock it after the filling or supply of the liquid is completed, the second on-off valve 43 returns to the first position from the second position with the elastic restoring force of the third biasing member 45. As a result, the bypass channel unit is closed again. That is, the operator locks the cylinder lock, which completes the series of operations with the second on-off valve 43.

As described above, according to the present embodiment, it is possible to reduce the possibility of an on-off valve of a liquid container 200 being opened or closed by mistake even at the stage of manufacturing the liquid container 200.

### OTHER EMBODIMENTS

The first to third embodiments have been described on the assumption that each liquid container 200 is an ink pack. However, the liquid container 200 may be an ink cartridge. The configuration of a typical ink cartridge is such that the ink cartridge is provided with a circuit board with a semiconductor storage element mounted on its surface, and various pieces of information such as the color of the ink and the remaining amount of the ink are stored in the semiconductor storage element. It should also be noted that a configuration in which a filter is installed in a channel in the outlet unit 2 is possible depending on the ink's characteristics.

In the first embodiment, the first dedicated tool 70 is rotated by driving the screwdriver motor 602. The first dedicated tool 70 may be rotated by, for example, driving a belt, driving a gear, or driving an air cylinder or the like.

The first and second embodiments have been described on the assumption that each liquid container 200 is mounted to the printing apparatus 100. Besides this example, the liquid containers 200 described in the first and second embodiments can be filled with a liquid in a similar manner in a manufacturing process as well. In this way, it will be easy to rework the liquid container 200 in a case where the amount of the liquid filled or the degree of deaeration falls outside the product's specification range. Moreover, it will be possible to collect a liquid container 200 that has been used from the user, refill the liquid into the liquid container 200, and reuse the liquid container 200 instead of discarding it.

In the first embodiment, an example in which an operator uses a key has been presented as an example of using the third dedicated tool 73. Alternatively, the third dedicated tool 73 may be included in the manufacturing apparatus 130.

With a liquid container according to the present disclosure, it is possible to stably open and close its valve element in a case of filling a liquid into the liquid container.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

1. A liquid container to be detachably mounted to a container mounting portion of a printing apparatus, comprising:
a bag body which contains a liquid therein; and
an outlet unit having
a supply channel unit which permits the liquid to be delivered to the printing apparatus from the bag body, and
a bypass channel unit which permits the liquid to be delivered to the bag body from the printing apparatus, wherein
in the supply channel unit, a check valve is disposed which permits the liquid to be delivered to the printing apparatus from the bag body and does not permit the liquid to be delivered to the bag body from the printing apparatus,
in the bypass channel unit, an on-off valve is disposed which is configured to be movable to a first position and a second position, the first position being a position at which the on-off valve closes the bypass channel unit to not permit the liquid to be delivered, the second position being a position at which the on-off valve opens the bypass channel unit to permit the liquid to be delivered, and
the on-off valve is configured to be freely moved between the first position and the second position by being operated by a tool from outside the liquid container to thereby switch opening and closing of the bypass channel unit.

2. The liquid container according to claim 1, wherein
the supply channel unit includes
a liquid supply hole to insert a hollow tube included in the printing apparatus,
a liquid inlet hole communicating with the bag body,
a liquid channel connecting the liquid supply hole and the liquid inlet hole to each other, and
the check valve disposed at an intermediate portion of the liquid channel, and
the bypass channel unit includes
a bypass channel hole communicating with the bag body,
a bypass channel branching off from an intermediate portion of the liquid channel forming the supply channel unit between the liquid supply hole and the check valve, and connected to the bypass channel hole, and
the on-off valve disposed at an intermediate portion of the bypass channel.

3. The liquid container according to claim 2, wherein
the printing apparatus includes a pump mechanism capable of delivering the liquid to the printing apparatus from the liquid container and delivering the liquid to the liquid container from the printing apparatus, and
in a state where the liquid container is mounted to the printing apparatus and the hollow tube is inserted in the liquid supply hole, the delivery of the liquid to the printing apparatus from the liquid container is performed by delivering the liquid through the supply channel unit of the liquid container and the hollow tube with the on-off valve of the bypass channel unit closed, and the delivery of the liquid to the liquid container from the printing apparatus is performed by delivering the liquid through the hollow tube, the liquid channel, and the bypass channel unit branching off from the liquid channel with the on-off valve of the bypass channel unit opened by the tool.

4. The liquid container according to claim 3, wherein
the liquid is an ink containing a pigment color material which is a precipitating component and a liquid medium in which the pigment color material is dispersed, and
the liquid container is configured such that liquid circulation can be performed in which the liquid is delivered to the printing apparatus from the liquid container through the supply channel unit and delivered to the liquid container from the printing apparatus through the bypass channel unit by using the pump mechanism in a case where the pigment color material in the ink in the printing apparatus or in the liquid container precipitates.

5. The liquid container according to claim 1, wherein
the on-off valve disposed in the bypass channel unit includes a valve element and a biasing member which has an elastic restoring force, and
the on-off valve is moved to the second position from the first position against the elastic restoring force of the biasing member by the tool to thereby open the bypass channel unit, and is returned to the first position from the second position by being biased by the elastic restoring force of the biasing member to thereby maintain a state of closing the bypass channel unit.

6. The liquid container according to claim 1, wherein
the outlet unit further has a rotation mechanism which rotates the tool, and
the on-off valve is moved to the second position from the first position in a case where the rotation mechanism is rotated in a first direction by the tool, and the on-off valve returns to the first position from the second position in a case where the rotation mechanism is rotated in a second direction which is opposite from the first direction.

7. The liquid container according to claim 1, wherein
the outlet unit further has a rotation mechanism which rotates the tool, and
the on-off valve is moved to the second position from the first position in a case where the rotation mechanism is rotated by a predetermined angle in a first direction by the tool, and the on-off valve is moved to the first position from the second position in a case where the rotation mechanism is further rotated by a predetermined angle in the first direction.

8. The liquid container according to claim 6, wherein
the tool is a screwdriver, and
the rotation mechanism has a shape of a recess corresponding to a shape of a tip portion of the screwdriver such that the screwdriver is exclusively used for the rotation mechanism.

9. The liquid container according to claim 7, wherein
the tool is a screwdriver, and
the rotation mechanism has a shape of a recess corresponding to a shape of a tip portion of the screwdriver such that the screwdriver is exclusively used for the rotation mechanism.

10. The liquid container according to claim 6, wherein
the tool is a key, and
the rotation mechanism includes a key cylinder having a keyhole corresponding to a shape of the key such that the key is exclusively used for the rotation mechanism.

11. The liquid container according to claim 7, wherein
the tool is a key, and
the rotation mechanism includes a key cylinder having a keyhole corresponding to a shape of the key such that the key is exclusively used for the rotation mechanism.

12. The liquid container according to claim 1, wherein the tool is a suction nozzle which sucks air in a space communicating with a surface of the on-off valve and an atmosphere to generate a negative pressure.

13. The liquid container according to claim 12, wherein a constituent material of a tip portion of the suction nozzle contains an elastic material.

14. A printing apparatus comprising:
a liquid container detachably mounted to a container mounting portion of the printing apparatus;
a hollow needle insertable into an outlet unit included in the liquid container; and
a tool for moving an on-off valve included in the liquid container, wherein
the liquid container includes:
a bag body which contains a liquid therein; and
an outlet unit having
a supply channel unit which permits the liquid to be delivered to the printing apparatus from the bag body, and
a bypass channel unit which permits the liquid to be delivered to the bag body from the printing apparatus,
in the supply channel unit, a check valve is disposed which permits the liquid to be delivered to the printing apparatus from the bag body and does not permit the liquid to be delivered to the bag body from the printing apparatus,
in the bypass channel unit, an on-off valve is disposed which is configured to be movable to a first position and a second position, the first position being a position at which the on-off valve closes the bypass channel unit to not permit the liquid to be delivered, the second position being a position at which the on-off valve opens the bypass channel unit to permit the liquid to be delivered, and
the on-off valve is configured to be freely moved between the first position and the second position by being operated by a tool from outside the liquid container to thereby switch opening and closing of the bypass channel unit.

15. A liquid container manufacturing apparatus comprising:
a mounting unit which mounts a liquid container;
a hollow needle insertable into an outlet unit included in the liquid container; and
a tool for moving an on-off valve included in the liquid container, wherein
the liquid container includes:
a bag body which contains a liquid therein; and
an outlet unit having
a supply channel unit which permits the liquid to be delivered to the printing apparatus from the bag body, and
a bypass channel unit which permits the liquid to be delivered to the bag body from the printing apparatus,
in the supply channel unit, a check valve is disposed which permits the liquid to be delivered to the printing apparatus from the bag body and does not permit the liquid to be delivered to the bag body from the printing apparatus,
in the bypass channel unit, an on-off valve is disposed which is configured to be movable to a first position and a second position, the first position being a position at which the on-off valve closes the bypass channel unit to not permit the liquid to be delivered, the second position being a position at which the on-off valve opens the bypass channel unit to permit the liquid to be delivered, and
the on-off valve is configured to be freely moved between the first position and the second position by being operated by a tool from outside the liquid container to thereby switch opening and closing of the bypass channel unit.

16. A liquid container manufacturing method for introducing a liquid into a liquid container by using
a manufacturing apparatus including:
a liquid tank;
a pump mechanism; and
a hollow tube, and
the liquid container including:
a bag body which contains a liquid therein;
a supply channel unit which permits the liquid to be delivered from the bag body to an outside;
a bypass channel unit which permits the liquid to be delivered to the bag body from the outside;
the supply channel unit including
a liquid supply hole to insert a hollow tube included in the manufacturing apparatus,
a liquid inlet hole communicating with the bag body,
a liquid channel connecting the liquid supply hole and the liquid inlet hole to each other, and
a check valve disposed at an intermediate portion of the liquid channel,
the bypass channel unit including
a bypass channel hole communicating with the bag body,
a bypass channel branching off from an intermediate portion of the liquid channel forming the supply channel unit between the liquid supply hole and the check valve, and connected to the bypass channel hole, and
an on-off valve disposed at an intermediate portion of the bypass channel; and
a tool insertion hole for operating the on-off valve from an outside with a tool,
the liquid container manufacturing method comprising driving the pump mechanism in a state where the liquid container is mounted to the manufacturing apparatus and the hollow tube is inserted in the liquid supply hole so as to deliver the liquid to the liquid container from the liquid tank of the manufacturing apparatus through the hollow tube, the liquid channel, and the bypass channel unit branching off from the liquid channel with the on-off valve of the bypass channel unit opened with the tool and deliver the liquid to the pump mechanism of the manufacturing apparatus from the liquid container through the supply channel unit of the liquid container and the hollow tube with the on-off valve of the bypass channel unit closed and thereby circulate the liquid and introduce the liquid into the liquid container.
